(19) United States
(12) Patent Application Publication
(10) Pub. No.: US 2019/0050463 A1
(43) Pub. Date: Feb. 14, 2019

(54) DYNAMIC VISUALIZATIONS

(71) Applicant: BAE Systems Applied Intelligence US Corp, Milford, CT (US)

(72) Inventors: Harnish Goradia, Weehawken, NJ (US); Alexander Forrest, Wokingham (GB)

(73) Assignee: BAE Systems Applied Intelligence US Corp, Milford, CT (US)

(21) Appl. No.: 15/675,172

(22) Filed: Aug. 11, 2017

(51) Int. Cl. G06F 17/30; G06F 9/44; G06T 11/20

(52) U.S. Cl. CPC G06F 17/30554; G06T 11/206; G06F 9/4443; G06F 17/30368

(57) ABSTRACT

Systems, methods and programs for updating a visualization are provided. A visualization is updated dynamically based on new or modified data or schema in at least one data store. For example, a computing device may poll a data store for changes, determine whether a change has occurred, update aggregations of the data, generate at least one new aggregation of the data, determine whether a visualization change is needed, determine the visualization change for a display of attributes, send the visualization change to a display device; and send a notification to a user indicating the visualization change. The visualization change includes at least one of position on a display, size of a graphic and type of the graphic for an attribute.

### FIELD OF THE DISCLOSURE

This disclosure relates to dynamically updating a visualization displayed on a user display. More particularly, this disclosure relates to an apparatus, methods and programs for updating a visualization displayed based on new or modified data or schema in at least one data store.

### BACKGROUND

Visualization refers to the presentation of data in pictorial or a graphical manner. Numerous factors impact a visualization including, but not limited to, location of a display, size of a picture or graphic, type of picture or graphic including color, and font size or type. Each of these factors influences how a user sees the information. Visualization is important as it is the interface to the underlying data and used to identify patterns such as identifying areas that need to be further monitored.

As the underlying data set expands, the manner in which the data is visualized becomes more valuable. For example, “big data” refers to extremely large data sets that can be analyzed to reveal trends, associations, and patterns. Given the size of the data, it is important to have a visualization that can efficiently and accurately capture the aggregations, e.g., groups, sorts, mathematic or logical relationships between the data for one or more schema. The data may be structured, such as relational data, semi-structured, such as XML data or unstructured, such as documents (WORD, PDF, and media logs).

Moreover, the data continuous is modified or new data being added as it becomes available. New definitions are generated (schema).

The visualization must be able to account or adapt to the change.

### SUMMARY

Accordingly, disclosed is a non-transitory computer-readable medium comprising instructions, that, when executed by at least one processor of a computing device, causes the computing device to poll, periodically a data store for changes in data or schema, determine whether the data or schema has changed, update, using at least the changed data or schema, aggregations of the data, generate at least one new aggregation of the data, using at least the changed data or schema, determine whether the updated aggregations or the at least one new aggregation of the data triggers a visualization change for a display of attributes in a display visualization, respectively associated with the updated aggregations or the at least one new aggregation, determine the visualization change for the display of the attributes, respectively associated with the updated aggregations or the at least one new aggregation, send the visualization change to a display device; and send a notification to a user indicating the visualization change. The visualization change includes at least one of position on a display, size of a graphic and type of the graphic for an attribute.

### BRIEF DESCRIPTION OF THE FIGURES

FIG. 1 depicts a block diagram of a visualization apparatus in accordance with aspects of the disclosure;

FIG. 2 depicts a block diagram of a visualization engine executed by a processor, such as a CPU, in accordance with aspects of the disclosure;

FIG. 3 depicts a block diagrams of a memory in accordance with aspects of the disclosure;

FIG. 4A depicts a block diagram for the change detection module and FIG. 4B depicts a flow chart for the change detection module in accordance with aspects of the disclosure;

FIG. 5A depicts a block diagram for the aggregation module and FIG. 5B depicts a flow chart for the aggregation module in accordance with aspects of the disclosure;

FIG. 6A depicts a block diagram for the visualization module and FIG. 6B depicts a flow chart for the visualization module in accordance with aspects of the disclosure;

FIG. 7 depicts a flow chart for conflict resolution in accordance with aspects of the disclosure;

FIG. 8 depicts a flow chart for a finalization of the visualization in accordance with aspects of the disclosure;

FIG. 9 depicts a flow chart for feedback processing in accordance with aspects of the disclosure;

FIG. 10A depicts an example of a dashboard scoring in accordance with aspects of the disclosure;

FIG. 10B depicts another example of a dashboard scoring in accordance with aspects of the disclosure;

FIG. 11 depicts an example of an attribute table in accordance with aspects of the disclosure;

FIG. 12 depicts an example of a conflict resolution table in accordance with aspects of the disclosure; and

FIG. 13 depicts an example of a type of graphic decision chart in accordance with aspects of the disclosure.

### DETAIL DESCRIPTION

### Definitions and Abbreviations

DSME-refers to a domain subject material expert. A DSME is a person familiar with the subject matter of the underlying data in a data store. For example, the subject matter may be, but not limited to, network security, marketing, social media, banking, and medicine.

UESME or UISME-refers to a user experience or user interface subject matter expert. A UESME or UISME is a person familiar with characteristic of a visualization and how it impacts a user.

“Schema” refers to a definition of the data within the data store. For example, the schema may refer to a column definition of data in a table or database. By way of example of a column definition, a column definition may be number of times a network is accessed and type (type may refer to a specific web browser) in minutes. Another column definition may be number of times a network is access and type (type may refer to a specific web browser) in seconds.

“Aggregation” refers to any association or relationship between the data in the data store. An aggregation may be defined by one or more mathematical functions, and/or one or more logic function and/or grouping and/or sort of the data. For example, an aggregation may be adding the number of time the network is accessed using “Google Chrome®” within an hour (using the data track each min). Thus the aggregation may add data points from the column defining number of times a network is accessed and type (type may refer to a specific web browser) in minutes, but only including the data points for using Google Chrome®. The mathematical functions may be, but are not limited to, adding, subtracting, multiplication, division, log, sine and cosine. Logic functions may be, but not limited to, “and”, “or”, “not” and “xor”.

“Attribute” refers to the result(s) of the aggregation or the aggregation.

### DESCRIPTION

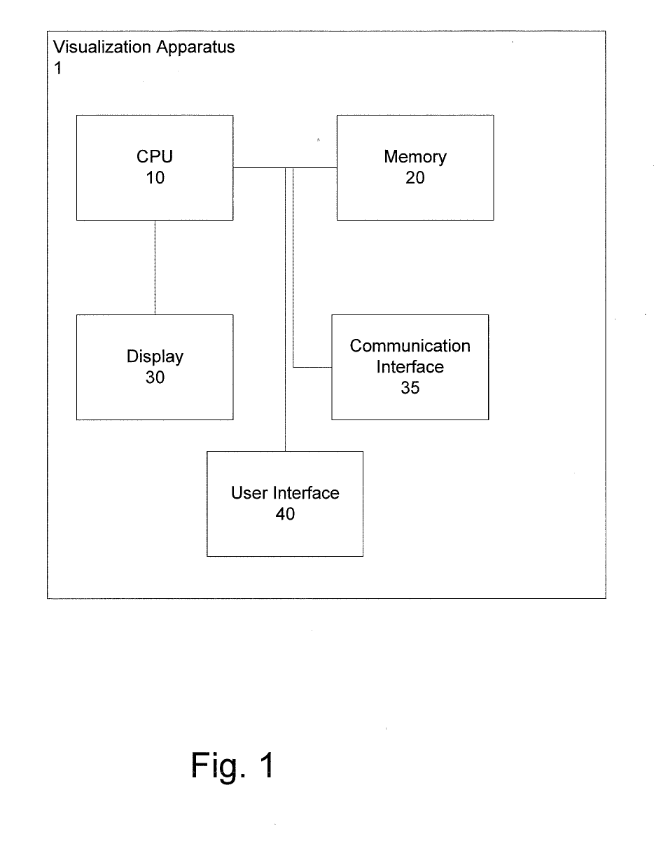

FIG. 1 depicts a block diagram of a visualization apparatus 1 in accordance with aspects of the disclosure. The visualization apparatus 1 is configured to update a displayed visualization (also referred to herein as a dashboard) on a user display based on changes to the data store. Changes to the data store refer to a modification, deletion and addition to the underlying data and/or a modification, deletion and addition of a schema. A typically dashboard includes display graphics for multiple attributes being monitored. The update to the dashboard may include the location of the graphic and/or size of the graphic and/or type of the graphic. The type of graphic may include size of font used in the graphic and/or color of the picture and/font.

As discussed in more detail later, the type of graphic may include, but is not limited to, a geo-heat map, line, pie, bar, column chart in 2-D or 3-D.

The data store may be any type of file system. For big data, the data store is typically multiple pieces of hardware located in different locations (distributed), such as large clusters of nodes (computers) collectively storing data. The distributed clusters of nodes are typically aggregated using programming models such as, but not limited to, Hadoop® (Hadoop distributed file system). In a hadoop distributed file system, a master node manages a file system metadata whereas the actual data is stored in the slave data nodes. The master nodes contain a list of where each file is stored (which of the slave data nodes) store the data. The data store may include structured data, such as relational data, semi-structured data such as XML data or unstructured data such as documents (WORD, PDF, and media logs). The databases may be non-relational or relational, SQL, non-SQL. The data store may include flat-files.

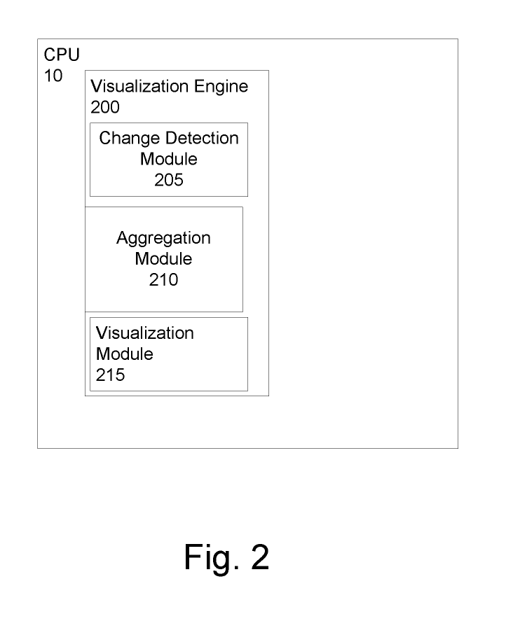

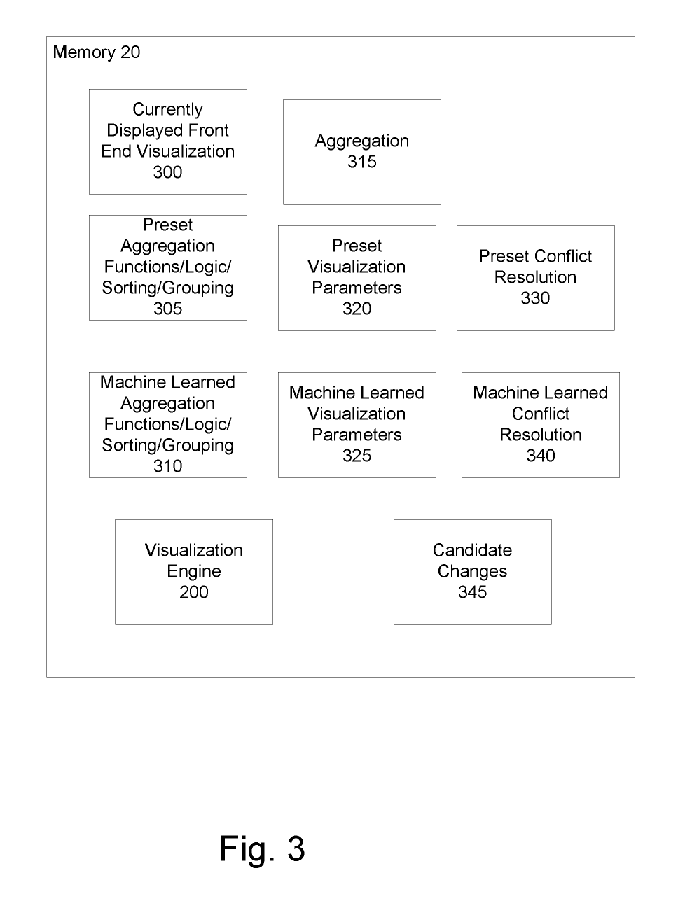

The visualization apparatus 1 may comprise a CPU 10 (an example of a processor), memory 20 (an example of a storage device), a display 30, a communication interface 35 and an user interface 40. The CPU 10 is described in FIG. 2. The memory 20 is described in FIG. 3.

The CPU 10 may be configured to execute one or more programs stored in a computer readable storage device such as the memory 20. For example, the CPU 10 may be configured to execute one or more programs or modules causing the CPU 10 to perform the methods described herein including the updating a visualization on a user display. The memory 20 may be, but not limited to, RAM, ROM and persistent storage. The memory 20 is any piece of hardware that is capable of storing information, such as, for example without limitation, data, programs, instructions, program code, and/or other suitable information, either on a temporary basis and/or a permanent basis.

The communication interface 35 may be a wired or wireless interface capable of transmitting and receiving data over a network.

The user interface 40 may be a keyboard, a mouse, or a touch panel. The DSME and UESME uses the user interface 40 to configure the CPU 10 to execute the visualization update. For example, the DSME and UESME uses the user interface 40 to store preset visualization parameters, conflict resolution parameters and aggregation function(s)/logic/sorting and/or grouping. Additionally, the DSME and UESME uses the user interface 40 to train the CPU 10 to update the same via machine learning.

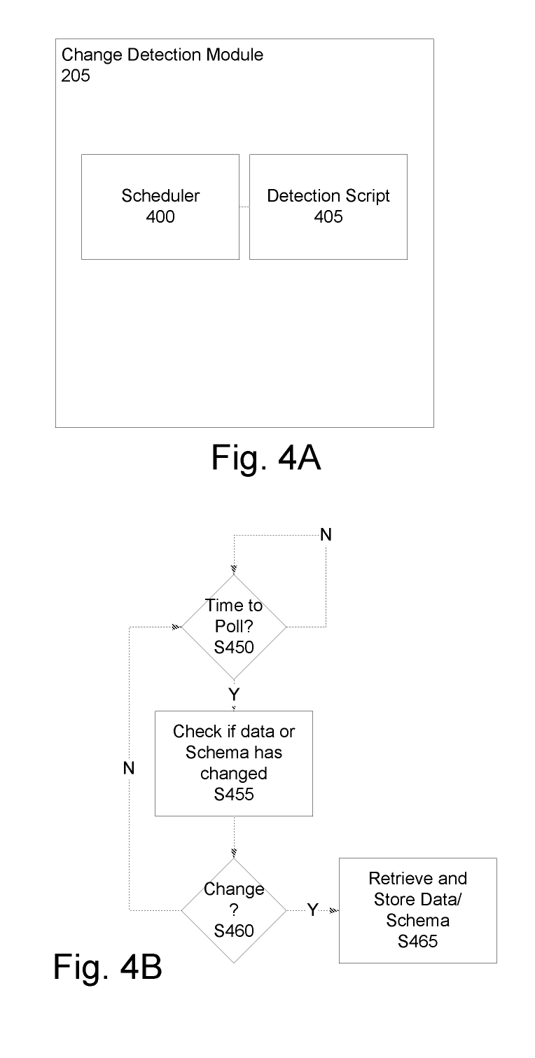

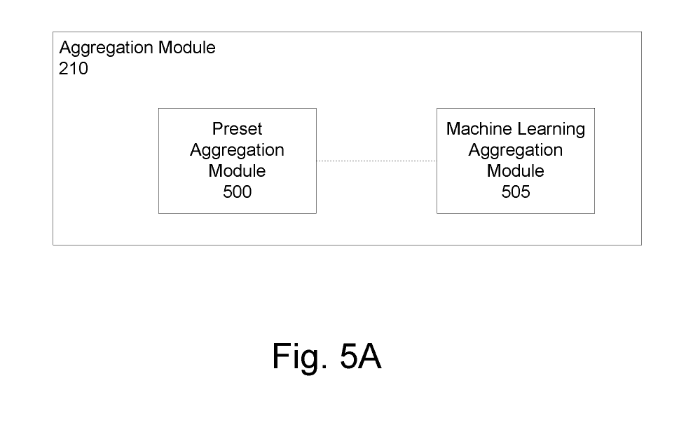

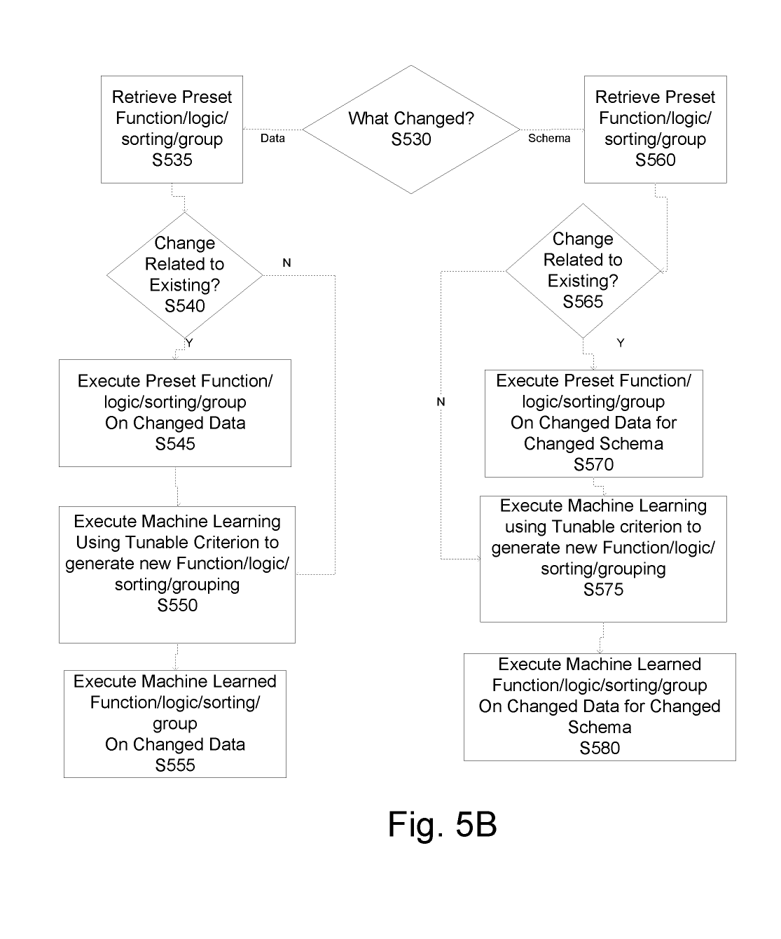

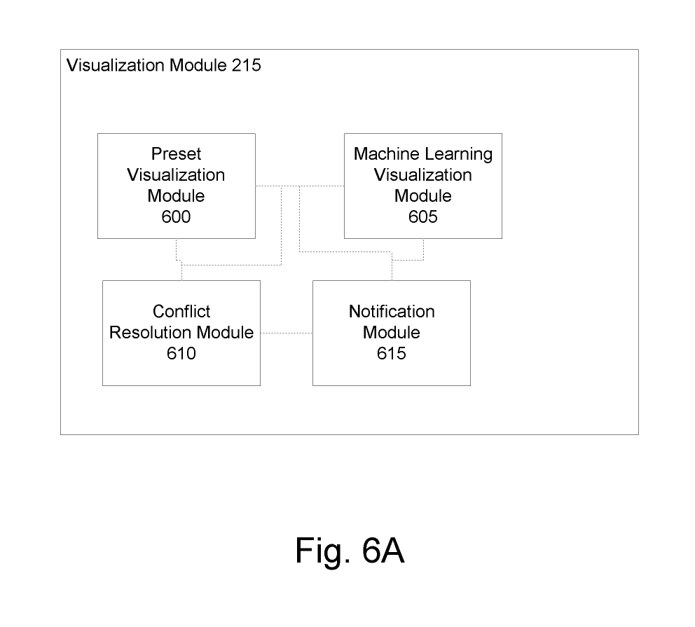

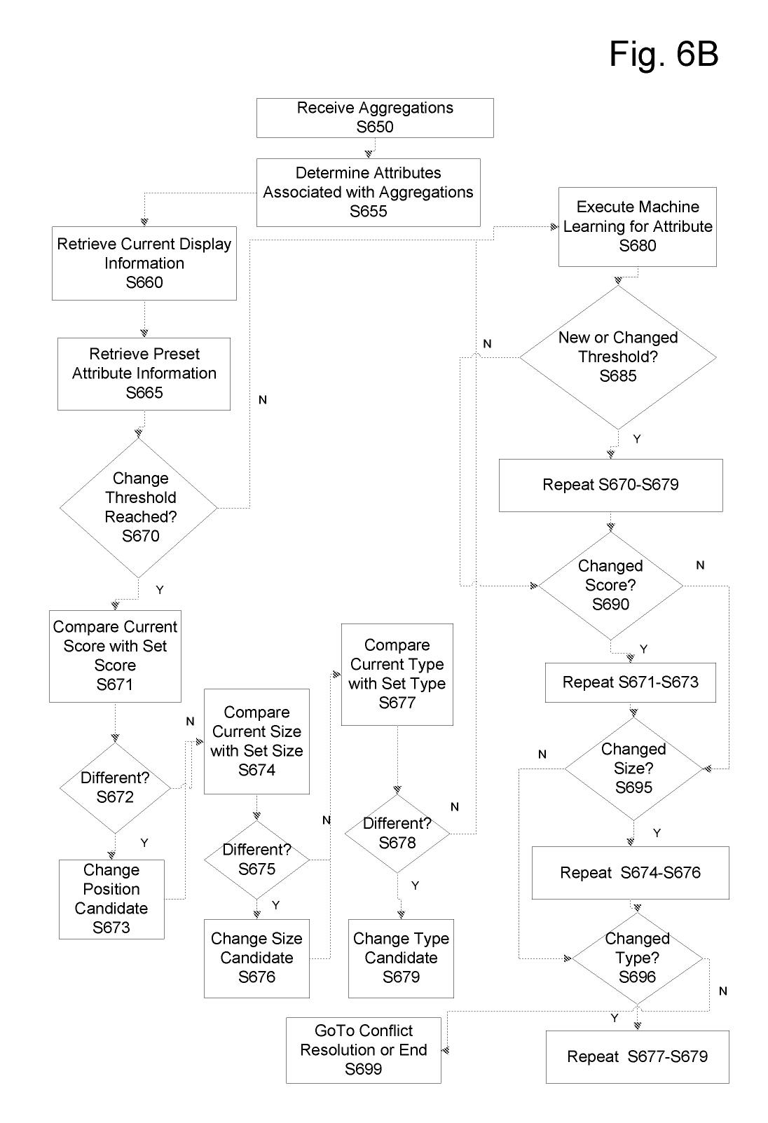

FIG. 2 depicts a block diagram of a visualization engine 200 executed by a processor, such as a CPU in accordance with aspects of the disclosure. The visualization engine 200 comprises a change detection module 205, an aggregation module 210 and a visualization module 215. The change detection module 205 will be described with respect to FIGS. 4A and 4B. The aggregation module 210 will be described with respect to FIGS. 5A and 5B. The visualization module 215 will be described with respect to FIGS. 6A-9. Although, the visualization engine 200 is shown in FIG. 2 (within the box for the CPU 10), the memory 20 stores the instructions or program codes for each of the modules as shown in FIG. 3 (visualization engine 200).

FIG. 3 depicts a block diagrams of a memory storing parameters used in the visualization engine in the CPU. The memory 20 comprises an area that stores a copy of what is currently being displayed on the front end display, e.g., current visualization 300. Each time the visualization or dashboard is updated, a copy of the update is stored in this area. The information stored in this area includes, but is not limited to, the type of graphic displayed in each scored regions, the position coordinates of the graphic, size, color, font etc. The CPU 10, executing the visualization module 215, uses the current visualization 300 to determine whether a change is needed.

The memory 20 comprises an area that stores preset aggregation functions/logic/sorting/grouping 305 (collectively preset aggregation information). The preset aggregation information is set by the DSME.

The memory 20 comprises an area that stores machine learned aggregation functions/logic/sorting/grouping 310 (collectively machine learned aggregation information). The machine learned aggregation information is generated by the CPU 10 executing the aggregation module 210.

The memory 20 comprises an area that stores the aggregation(s) 315. Each time, the CPU generates an aggregation or updates an existing aggregation, the aggregation is stored in memory in area 315.

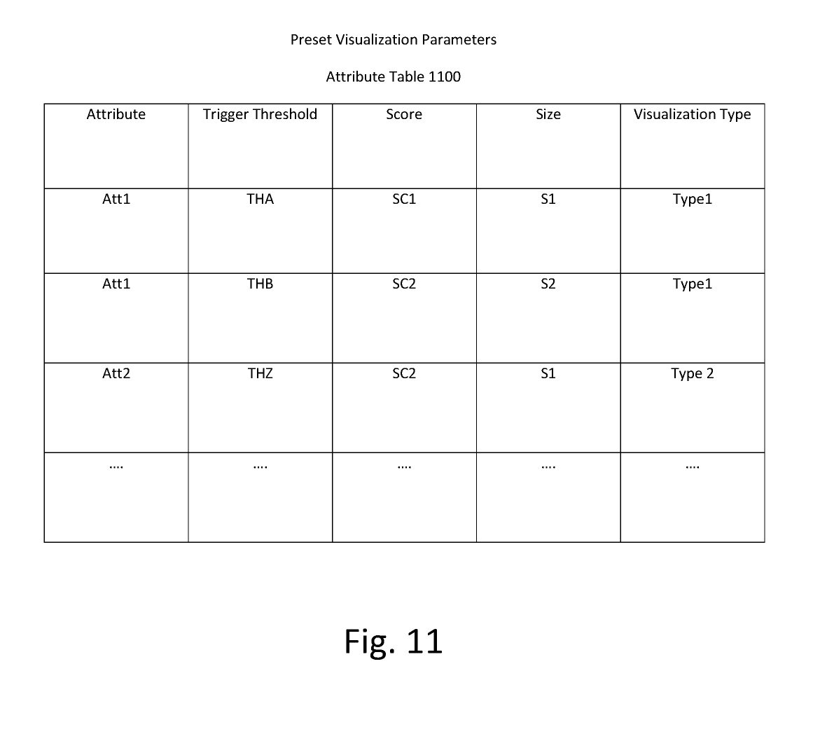

The memory 20 comprises an area that stores preset visualization parameters 320. The preset visualization parameters 320 are set by both the DSME and UESME. The preset visualization parameters 320 include thresholds, scores, size, type including font, etc. In an aspect of the disclosure, thresholds are set by the DSME and scores, size, type including font, etc. are set by the UESME. The preset visualization parameters 320 may be set for each aggregation. The visualization parameters may be stored as a table such as the example depicted in FIG. 11. CPU 10 executing the visualization module 215 uses the preset visualization parameters 325 to determine whether a change is needed.

The memory 20 comprises an area that stores machine learned visualization parameters 325. The machine learned visualization parameters 325 are generated by the CPU 10, executing the visualization module 325, based on its training by both the DSME and UESME. The machine learned parameters 325 include thresholds, scores, size, type, font, etc. In an aspect of the disclosure, the training for the thresholds is performed by the DSME and the training for scores, size, type, font, etc. are performed by the UESME. The machine learned visualization parameters 325 are generated for either existing aggregations or for new aggregations. CPU 10 executing the visualization module 215 uses the machine learned visualization parameters 325 (along with the preset) to determine whether a change is needed.

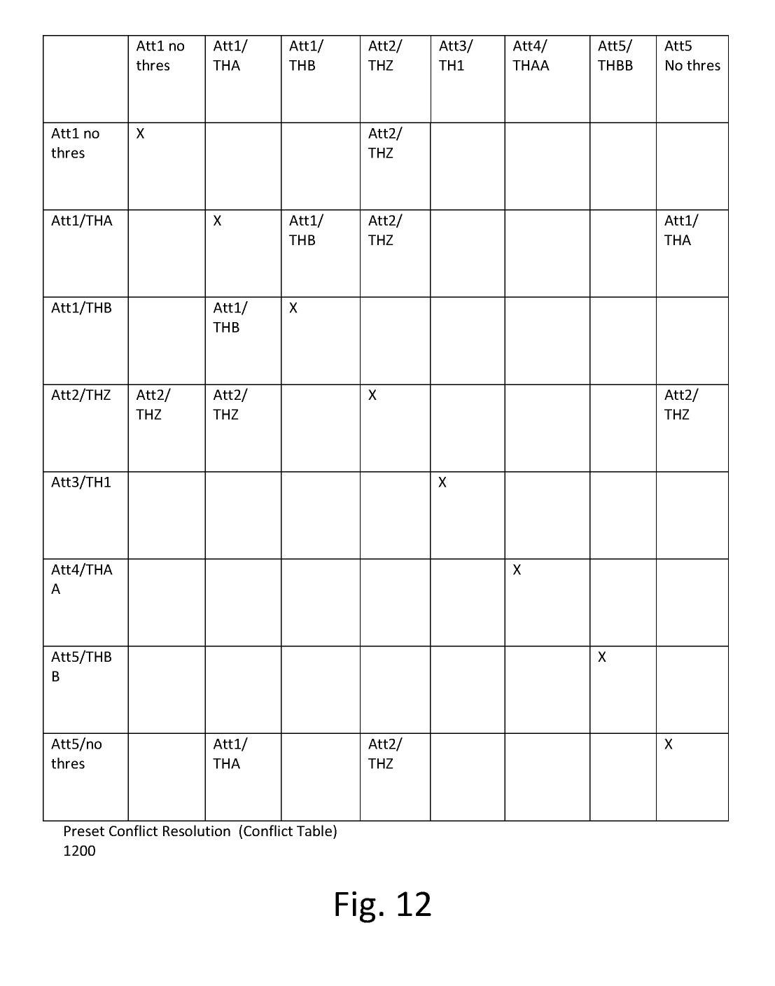

The memory 20 comprises an area that stores preset conflict resolution 330. The preset conflict resolution 330 is set by both the DSME and UESME. The preset conflict resolution 330 may be stored as a table, such as the example depicted in FIG. 12. The preset conflict resolution 330 contains priority information between different aggregations and associated threshold(s). CPU 10 executing the visualization module 215, when a conflict exists, uses the priority information to resolve any conflict.

The memory 20 comprises an area that stores machine learned conflict resolution 340. The machine learned conflict resolution 340 is generated by the CPU 10 executing the visualization module 215 based on training provided by both the DSME and UESME. The machine learned conflict resolution 340 contains priority information between different aggregations and associated threshold(s) including existing and new aggregations. CPU 10 executing the visualization module 215, when a conflict exists, uses the machine learned conflict resolution 340 (along with the preset) to resolve any conflict.

As shown in FIG. 4A, the change detection module 205 comprises a scheduler 400 and detection script 405. The scheduler 400 is configured to maintain a timing of when the detection script 405 polls the data store. The scheduler 400 may be a Cron which has a crontab file. The crontab file may include several time fields such as, but not limited to minutes, hour, day of month, month, and data of week. The crontab also include the command to be executed, such as the detection script 405. The Cron may be Unix® based or Linux based. The fields of the crontab file may be populated by the DSME to trigger the polling of the data store at a desired rate. Other scheduling programs may be used such as Chronos which may be used with Apache Mesos.

The detection script 405 polls the data store for updates or changes to either the data or scheme. Typically, the data store maintains a change log. The change log may include a time stamp of the change and a delta file having the change. Alternatively, the change log may include a time stamp of the change, an identifier for the change and a pointer to where the data associated with the change exists. The change log may require an API for excess to the information. Additionally, the change log may require credentials for excess, such as a user identifier and passcode. The change log may be centrally located in a single computing device in the data store, whereas the data may be located across many computing devices in the data store. Additionally, the change log may be distributed within the data store and located in multiple computing devices in the data store. When the change log is distributed, the detection script is configured to poll each of the locations, e.g., each change log.

The detection script 405 includes any credentials required for access to a change log including password. The detection script 405 causes a query or polling packet to be transmitted to the computing device(s) having the change log(s) via the user interface. In an aspect of the disclosure, the very fact that a change log exists is indicative of a change. Moreover, when the change log includes one or more time stamps indicating a time after a previous polling event, a changes has occurred.

In an aspect of the disclosure, the data store may respond to the query or polling packet by transmitting a copy of the change log. In another aspect of the disclosure, the data store may respond to the query or polling packet by transmitting an audit file containing only changes having a time stamp after the previous query or polling packet.

The CPU 10, executing the detection script 405, determines whether a change has occurred by examining the change log or the audit file it received from the data store.

FIG. 4B depicts a flow chart for the change detection module in accordance with aspects of the disclosure. At S450, the CPU 10 determines if it is time to query the data store (e.g., executing a Cron program). The CPU 10 comprises a clock which maintains the time. When the clock indicates that the current time coincides which a time set in the Cron, e.g., fields programmed in the Crontab, the scheduler 400 causes the CPU 10, executing the detection script 405 to query or poll the data store at S455 (“Y” at S450). The query includes credentials to access a change log and current time. The query may also include information regarding a time of prior query.

Responsive to the query, the data store, e.g., change log, will cause either a copy of the change log or an audit file containing any changes after the previous query to be transmitted to the CPU 10 via the communication interface 35.

At S460, the CPU 10, executing the detection script 405, determines if there are any changes, e.g., either to the data or the schema. The change log or audit file is temporally stored in memory. The CPU 10, executing the detection script 405, examines the change log or audit file to determine if there were any changes to either the data or a schema after the previous query. In an aspect of the disclosure, the CPU 10 examines the time stamps of any change. If the time stamp is after the previous query, the CPU 10 determines that the change is new. In an aspect of the disclosure the existence of a change log indicates that there is a change in data or schema.

At S460, when the result of the determination indicates that there was a change (“Y”), the CPU, executing the detection script 405, updates the new or changed data or schema, if needed (S465). In an aspect of the disclosure, when the response to query contains the data or schema change (as opposed to a point or indicator where the change took place, the CPU 10 retrieves the changed data or schema from memory 20 at S465. In another aspect of the disclosure, when the change log or audit file includes a pointer, the CPU 10, executing the detection script 405, issues a request to the data store for the update. The request includes a time stamp of the change, the identifier and the pointer. In an aspect of the disclosure, the request is directly transmitted to the computing device storing the change. Upon receipt, the data is stored in memory 10.

Any determined change is forwarded to the aggregation module 210.

FIG. 5A depicts a block diagram for the aggregation module 210. The aggregation module 210 comprises a preset aggregation module 500 and a machine learning aggregation module 500. The preset aggregation module 500 generates aggregations using preset or existing function(s)/logic/sorting and/or grouping set in memory, e.g., 305. Thus, the preset aggregation module will update existing aggregations or new aggregation(s) that were already set.

The machine learning aggregation module 505 generates aggregations using machine learned function(s)/logic/sorting and/or grouping. Thus, the machine learning aggregation module 505 will update existing aggregations or new aggregation(s) using newly generated function(s)/logic/sorting and/or grouping. Machine learning aggregation module may include machine learning programs such as MLlib, which is JAVA® based. MLlib is an Apache Spark™ scalable machine learning library. MLlib is compatible with hadoop clusters. The machine learning aggregation module may also include or alternatively use TensorFlow®, which is also an open source software for machine learning.

The machine learning aggregation module 505 is trained to generate new functions/logic/sorting and/or grouping by the DSME. For example, the DSME, using known aggregations, trains the machine learning aggregation module 505 to look for changes in the data/schema and how to account for the same.

FIG. 5B depicts a flow chart for the aggregation module 210 in accordance with aspects of the disclosure.

At S530, the CPU 10, executing both modules 500/505, determines what changed, e.g., classifying the change into data only or schema. The preset aggregation module 500 and machine learning aggregation module 505 may be executed sequentially or at the same time as both need to know what changed.

The aggregation module 210 is triggered by the change detection module 205 when the change detection module 205 forwards any changes. The CPU 10 may process a change in data separately from a change in schema (and data).

At S535, the CPU 10, executing the preset aggregation module 500, retrieves any preset information stored in memory 305. The preset information may include function/logic/sorting and/or grouping information for one or more aggregations. At S540, the CPU 10, executing the preset aggregation module 500, determines if the change in data is related to any of the existing aggregations S540.

For example, the additional data may include data points regarding network access and one of the functions for one of the aggregations may include an addition of all of the data points referring to access from a website for an hour. Therefore, the CPU may determine that the updated data relates to a function for one of the aggregations.

At S545, the CPU 10, executing the preset aggregation module, execute the preset information using the updated data (and the previous data) when the change relates to existing aggregations (Y at S540). Continuing with the above example, if the data existing prior to the update only included data for 30 minutes and the current update includes data for the other 30 mins, the CPU 10 would add the new data to the old data.

Another example may be a number of credit card transactions over $1000 per credit card, tracked by card number, over a day. The aggregation may be defined by an addition of data points (sorted by amount). If the polling of the data store occurs more frequently than a single day, then each polling cycle includes a sub-set of the aggregation. Each update in data would result in the CPU 10 retrieving the aggregation from memory, e.g., number of credit card transactions over $1000, per credit card, tracked by card number, over a day (at S535) and determining the updated data to be related (S540), the CPU would then add the new data to the old data (S545) using the preset function.

At S550, the CPU 10, using the machine learning aggregation module 505, may generate additional function/logic/sorting/grouping. For example, the CPU 10, using the machine learning aggregation module 505, may notice that the number of credit card transactions over $1000, became significantly more frequency, based on the change in data. According to its training, e.g., DSME tunable criterion, the machine learning aggregation module 505, may determine that new aggregations need to be generated. For example, the machine learning aggregation module 505 may create an aggregation of by grouping transactions over $1000 by location of the transaction or by transaction product type. Therefore, based on the change in data, the CPU 10, executing the machine learning aggregation module 505 may generate one or more new aggregations which are defined by new functions/logic/sorting and/or grouping.

At S555, the CPU 10, using the machine learning aggregation module 505, executes the machine generated function(s)/logic/sorting and/or grouping to determine the aggregation. For example, the CPU 10 applies the generated function(s)/logic/sorting and/or grouping on the changed data. In an aspect of the disclosure, the CPU may also apply the generated function(s)/logic/sorting and/or grouping on the existing data.

If at S540, the change in data does not relate to any of the preset aggregate information (not related to any preset aggregation), the CPU 10 proceeds to S550 and executes machine learning, e.g., is new aggregations/functions/logic/sorting/grouping needed? For example, using the above example of number of credit card transactions over $1000, per credit card, tracked by card number, over a day as a preset aggregation, and if the update includes an excessive number of small credit card transactions within a short period of time, the CPU 10, executing the machine learning module 505, may generate an aggregation (new function/logic/sorting/grouping) of number of transactions in a period of time, number of transactions for a specific credit card number, number of transactions for a specific product and/or number of transaction processed by a specific machine at S550 and execute the same at S555.

A similar process is executed by the CPU 10 upon a determination of a change in schema.

At 560, the CPU 10, executing the preset aggregation module 500, retrieves any preset information stored in memory 305. The preset information may include function/logic/sorting and/or grouping information for one or more aggregations. At 565, the CPU 10, executing the preset aggregation module 500, determines if the change in schema is related to any of the existing aggregations S540. For example a change in schema may include tracking network access in five minute increments for an hour verses tracking network access in 1 minute increments for the same hour. The data points for each “cell”, e.g., 1 minute increment, would be added to track for five minute increments. The change may be retroactive in the data store, e.g., the cells in the new schema would be populated based on existing data. In an aspect of the disclosure, the aggregation module may populate the cells if they were not populated in the data store. Depending on the change in the schema, the change may result in none of the preset aggregations (function(s)/logic/sorting and/or group) being related to the change (“N” at S565). In that case, the CPU 10, executing the machine learning aggregation module 505 may generate new aggregations (function(s)/logic/sorting and/or group) at S575.

For example, a preset aggregation may include number of cases of influenza per state and another preset aggregation may include a number of deaths related to the same. When a new schema is influenza shots is added (and detected), the CPU 10, executing the machine learning module 505, may generate function(s)/logic/sorting and/or group that correlates influenza shots with number of cases per state or deaths.

At S580, the CPU 10, executing the machine learning module 505, performs the newly generated function(s)/logic/sorting and/or group on the new information (schema and/or data). In an aspect of the disclosure, the CPU 10 also applies the newly generated function(s)/logic/sorting and/or group on the existing data/schema as well.

If at S565, the change in schema relates to the existing aggregation(s), e.g., preset function(s)/logic/sorting and/or group, then the CPU 10, executing the preset aggregation module 500, performs the preset function(s)/logic/sorting and/or group on the changed schema (and data) at S570. In an aspect of the disclosure, the CPU 10 also applies the preset function(s)/logic/sorting and/or group on the existing data/schema as well.

The aggregation module 210 outputs the aggregations (updated) to the visualization module 215.

FIG. 6A depicts a block diagram for the visualization module 215. The visualization module 215 comprises a preset visualization module 600, a machine learning visualization module 605, a conflict resolution module 610 and a notification module 615.

The preset visualization module 600 generates candidate visualizations for each attribute to be displayed on a dashboard using preset parameters in memory, e.g., 320.

The machine learning visualization module 605 generates candidate visualizations for each attribute to be displayed on a dashboard using machine learned parameters 325. The generated parameters are stored in memory 10 for subsequent use.

Machine learning visualization module 605 may include the machine learning programs referenced above. The machine learning visualization module 605 is trained to generate candidate visualization by the DSME and the UESME.

The conflict resolution module 610 resolves two types of conflict using resolution parameters that may be preset or machine learned. In an aspect of the disclosure, the preset conflict resolution parameter(s) 330 may be updated through machine learning and the updated parameter may be stored in memory 10. The candidates determined by the preset visualization module 600 and the machine learning visualization module 605 are output to the conflict resolution module 610.

The notification module 615 alerts the user or operator of the front end display that a visualization or dashboard has been updated. The notification module 615 may push the notification to the user. The notification may be in the form of a pop-up window, a text message or an email.

FIG. 6B depicts a flow chart for the visualization module 215 in accordance with aspects of the disclosure. At S650, the visualization module 215 receives the aggregation(s) from the aggregation module 210. The aggregations are also stored in memory, e.g., aggregation 315.

At S655, the visualization module 215 determines the attribute respectively associated with each aggregation. As noted above, the attribute may be the result of the aggregation, e.g., the result of applying the function(s)/logic/sorting and/or group to the aggregation. Additionally, the attribute may be a depiction of each of the data points in the aggregation. For example, the attribute may be a single number, a group of numbers or data points, a percentage, or a location on a map.

At S660, the CPU 10 (the visualization module 215) retrieves the current display visualization or dashboard which is stored in memory 10, e.g., currently displayed front end visualization 300.

Additionally, at S665 the CPU 10, executing the preset visualization module 600, retrieves the preset attribute information from memory 10 (preset visualization parameters 320). FIG. 11 shows an example of an attribute table 1100. The attribute table 1110 (preset visualization parameters) includes for each attribute a trigger threshold, a score, a size and visualization type. The score, size and visualization type is set by a UESME.

The trigger threshold is a value that is set which may cause the graphic for the attribute to change. The trigger threshold is set by the DSME. For example, if the attribute is a total number of accesses, the trigger threshold may be set of a value such as 100, above which may trigger the graphic to change. In another example, the attribute may be a total number of credit card purchases above $1000, the trigger threshold may be set to a value such as 10. An attribute may have multiple trigger thresholds. For example, the attribute may be a total number of credit card purchases above $1000, a first trigger threshold may be set to a value such as 10 and a second trigger threshold may be set to a value such as 25.

At S670, the CPU 10, executing the preset visualization module 600, compares the value of the attribute with the trigger threshold(s) associated with the attribute. If the value of the attribute has reached the trigger threshold (“Y” at S670), the preset visualization module retrieves the score associated with the trigger threshold and compares the same with the score of the attribute in the currently displayed front end visualization at S671.

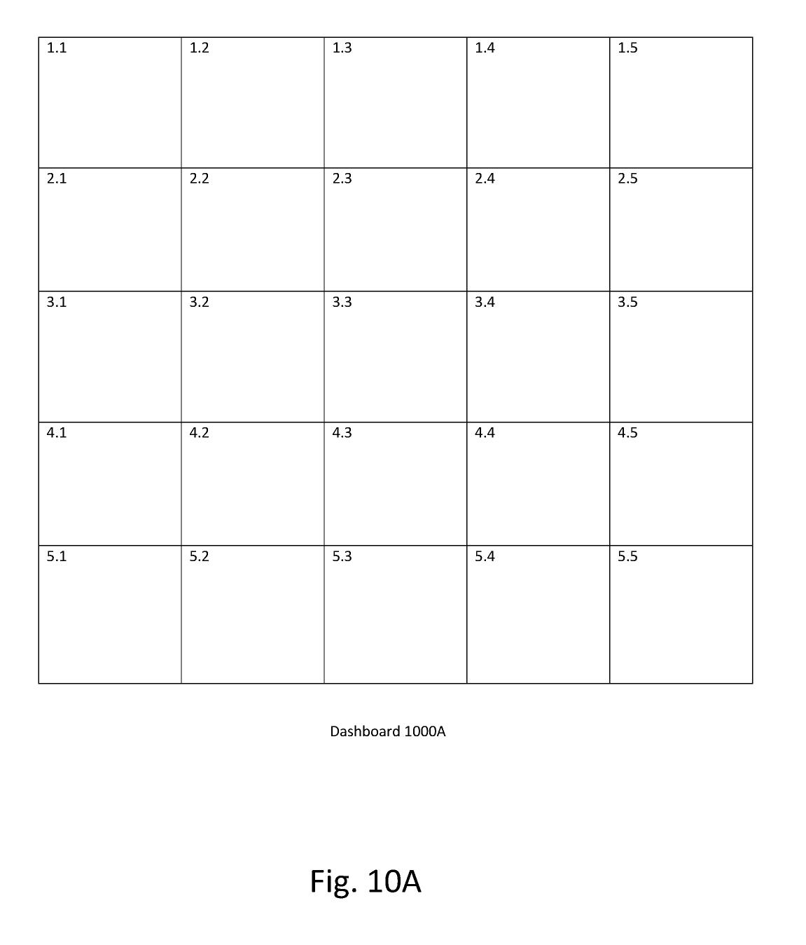

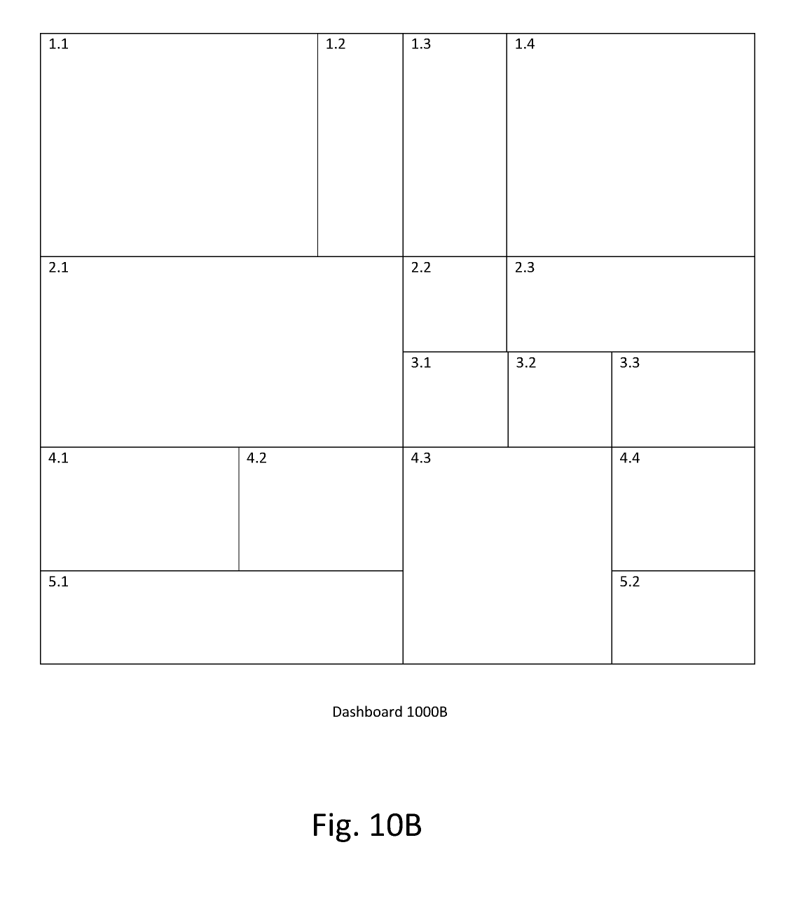

The score refers to a position on the dashboard or the front end display. FIGS. 10A and 10B depicts examples of a scoring system. The dashboard may be divided into equal sized regions (FIG. 10A) or unequal size regions (FIG. 10B). For example, in FIG. 10A, a region on the top left has the highest score, 1.1, whereas the region on the lower right has the lowest score, e.g., 5.5. In the example depicted in FIG. 10A, there are 5 rows and five columns. The first row is scored with 1.x, where “x” represents the column number.

In FIG. 10B, the dashboard 1000B includes uneven sized regions. For example, region score 1.1 is larger than region score 3.2 and 5.3.

Referring to the example attribute table 1100 when the trigger threshold for Att1 is THA, the associated score is SC1. Thus, the CPU 10, executing the preset visualization module 600, compares the associated score, e.g., SC1, with the score of the region where the attribute is currently displayed. If the position is different, e.g., not the same score (“Y” at S672), the attribute become a candidate for a change in position of the associated graphic at S673.

If the position is the same, e.g., same score (“N” at S672), the CPU 10, executing the preset visualization module 600, compares the associated size (from the attribute table 1100) with the current size as reflected in the currently displayed front end visualization 300 at S674. For example, using Att1 and THA, the associated size is S1. The size refers to the number of regions in which the graphic occupies. For example, a graphic occupying score region 1.1-1.2 has a size of 2.

Thus, the CPU 10, executing the preset visualization module 600, compares the associated score, e.g., S1, with the size of the graphic of the attribute is currently displayed. If the size is different, e.g., not the same size (“Y” at S675), the attribute become a candidate for a change in size of the associated graphic at S676.

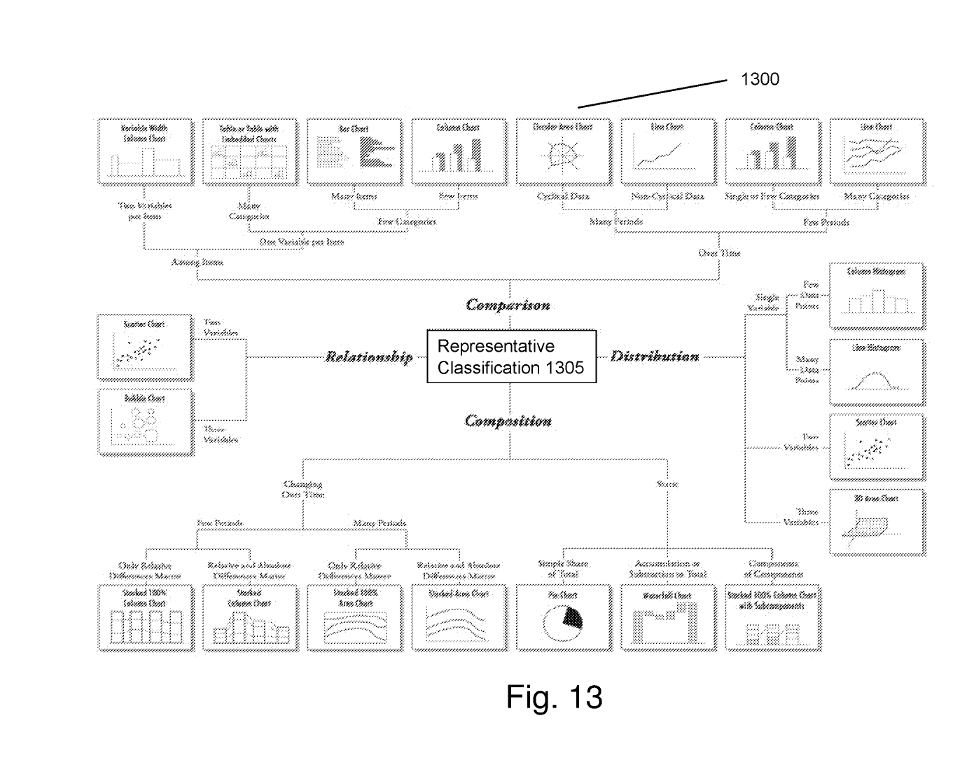

If the size is the same (“N” at S675), the CPU 10, executing the preset visualization module 600, compares the associated type of the graphic (from the attribute table 1100) with the current graphic as reflected in the currently displayed front end visualization 300 at S677. For example, using Att1 and THA, the associated type is Type1. The type refers to the kind of graphic such as chart, graphs, tables, geomaps. FIG. 13 shows non-limiting examples of the types of graphic including relationship, comparison, distribution and composition graphics. The type herein also refers to font, color and size of font. Thus, a change in “type” does not necessarily mean a different kind of graphic such as going from a chart to a table or a graph. For example, if the aggregation is number of cases of influenza, by state and the attribute is total number and a geo-map is used and the threshold trigger is 25,000 case, the “type” may change from a geo-map showing all 50 states of the United States to a geo-map showing a state or region where the number of cases exceeds 25,000, where the state is depicted in bright red.

Thus, the CPU 10, executing the preset visualization module 600, compares the associated type, e.g., Type1, with the type of the graphic of the attribute is currently displayed. If the type is different, e.g., not the same type (“Y” at S678), the attribute become a candidate for a change in type of the associated graphic at S679.

If at S670, the trigger threshold has not been reached or if the position, size and type are the same (“N” at S678), the CPU 10, executing the machine learning visualization module 605, determines whether to update the parameters, such as threshold, score, size, and type.

The machine learning visualization module 605 is trained for updating a score, size and type by the UESME. The DSME may also help the training.

FIG. 13 also shows a representative training including examples of classification 1305 and representative types of graphs 1300. In an aspect of the disclosure, the type may be classified into relationship, comparison, distribution and composition (among others). A distribution type may also be further classified into single, two or three variables. The single variable may also be classified into a few or many data points. Therefore, the training for a visualization type may include teaching the machine learning visualization module 605 to examine the aggregation(s) and attributes to determine the type of aggregation and attribute (e.g., distribution) and number of variables and data points in the aggregation (attributes). For example, as shown in FIG. 13 for a three variable distribution a 3D area chart may be used whereas for a single variable—few data points, a column histogram may be used.

Further, for a comparison, the comparison may be classified into time verses items comparison. The time may also be classified into few or many periods. For the many period classification, a further classification may include critical and non-critical data. Critical data over many periods of time may use a circular area chart.

Items may also be classified into other sub-classifications and each may include a certain type of graphic. Therefore, the training for a visualization type may include teaching the machine learning visualization module 605 to examine the aggregation(s) and attributes to determine the type of aggregation and attribute (e.g., comparison over time or over items) and number of variables and data points in the aggregation (attributes)(many verses few items, criticality of the data, many variables).

Furthermore, for a relationship, the classification may be sub-classified by number of variables as well and a graphic used may be associated with the number of variables. For example, a bubble chart may be used when there are three variable. Therefore, the training for a visualization type may include teaching the machine learning visualization module 605 to examine the aggregation(s) and attributes to determine the type of aggregation and attribute (e.g., relationships) and number of variables and data points in the aggregation (attributes)(two or three, etc.).

Furthermore, for a relationship, the classification may be sub-classified by time (static verses dynamic), number of periods, and extent of differences over time. Therefore, the training for a visualization type may include teaching the machine learning visualization module 605 to examine the aggregation(s) and attributes to determine the type of aggregation and attribute (e.g., composition, static verses dynamic in time) and extent of changes in data and number of periods.

If the machine learning visualization module 605 updates the parameters, the updated parameters are stored in the memory 20 (machine learned visualization parameters 325).

The CPU 10, executing the machine learning visualization module 605, determines which parameters have been updated (S685, new or changed trigger threshold), (S690 score), (S695 size) and (S696 type). For example, at S685, the CPU 10 determines if there is a new or updated threshold. The CPU 10 retrieves a threshold from the machine learned visualization parameters 325 from memory 10 and compares the same with the trigger threshold in the preset parameters such as in the attribute table 1100. If they are different S670-S679, are repeated for the updated or new trigger threshold.

If there are no new or updated thresholds, the CPU 10, continues to execute the machine learning visualization module 605 at S690.

At S690, the CPU 10 determines if there is a new or updated score. The CPU 10 retrieves a score from the machine learned visualization parameters 325 from memory 10 and compares the same with the score in the preset parameters such as in the attribute table 1100. If they are different, S671-S673 are repeated for the updated or new score.

If there are no new or updated scores, the CPU 10, continues to execute the machine learning visualization module 605 at S695.

At S695, the CPU 10 determines if there is a new or updated size. The CPU 10 retrieves a size from the machine learned visualization parameters 325 from memory 10 and compares the same with the size in the preset parameters such as in the attribute table 1100. If they are different, S674-S676 are repeated for the updated or new score.

If there are no new or updated sizes, the CPU 10, continues to execute the machine learning visualization module 605 at S696.

At S696, the CPU 10 determines if there is a new or updated type. The CPU 10 retrieves a type from the machine learned visualization parameters 325 from memory 10 and compares the same with the type in the preset parameters such as in the attribute table 1100. If they are different, S677-S679 are repeated for the updated or new type.

Once all of the steps are repeated or no additional changes are determined, the CPU 10, execute the conflict resolution module 610, if needed. The candidates for a position change (S673), size change (S676) and type change (S679) are stored in memory 10 (as candidate changes 345).

FIG. 6B depicts S685, S690, S695 and S696 being executed separately. However, the CPU may execute the above together and check for any changes and only repeat the steps after the threshold, score, size and type has been check for a change or new value.

If there are no changes to the score, size and type, the visualization engine 200 also checks to make sure the axes are correct. When the axes need to be updated, the visualization engine 200 updates the axes. Also even if there are no changes to the score, size and type, the visualization engine adds the new data (or schema) to the graphic and stores the same to the currently displayed front end visualization 300, e.g., overwrites the previous version, such that when the updated visualization or dashboard is sent to the front end display, the visualization reflects the new data (or schema).

There are two types of visualization conflicts: (1) conflict between visualization candidate changes determined from preset parameters and visualization candidate changes determined from machine learned parameters; and (2) conflict between attributes currently displayed at a specific score (and size) and attribute candidates having changes in score and size that would result in two different attributes having the same score(s).

The first type of conflict may result from a difference in a score/size/type determined for an attribute based on the preset parameters and score/size/type determined for the same attribute based on the machine learning. In other words, there may be different scores/sizes and types to select from.

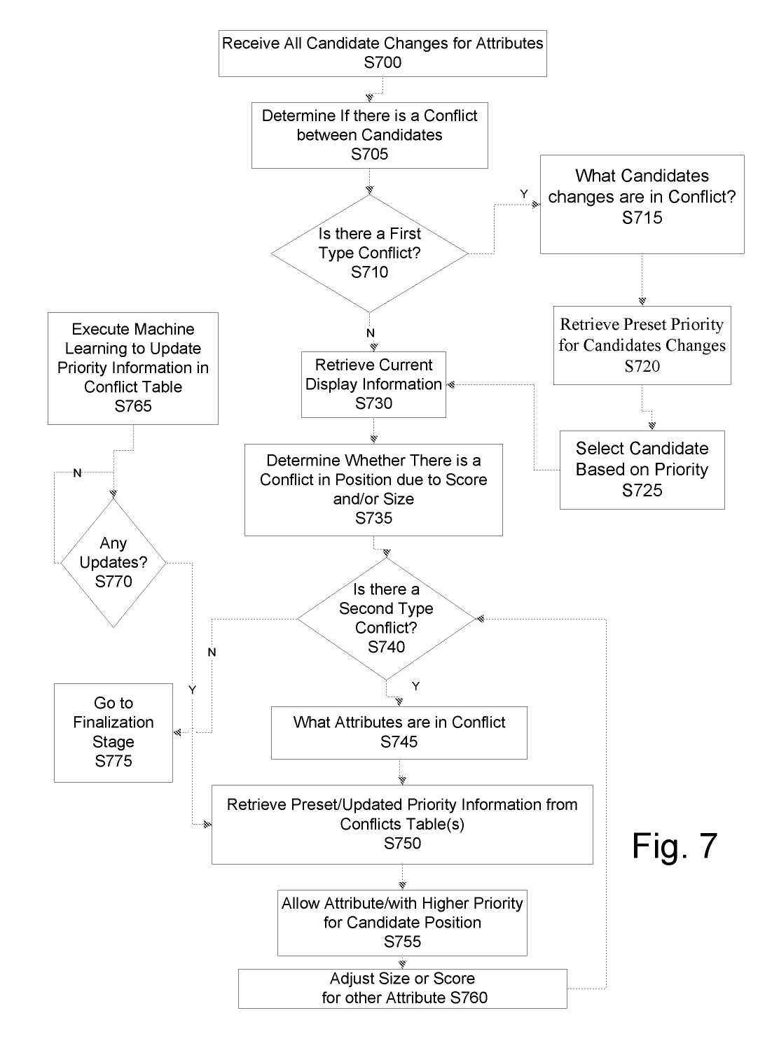

FIG. 7 depicts a flow chart for conflict resolution in accordance with aspects of the disclosure.

The conflict resolution module 610 receives all candidate changes for each attribute from the preset visualization module 600 and the machine learning visualization module 605 at S700. In another aspect of the disclosure, the preset visualization module 600 and the machine learning visualization module 605 provides a trigger signal to the conflict resolution module 610 which causes the conflict resolution module 610 to retrieve all candidate changes for each attribute from memory 20 (saved in candidate changes 345).

At S705, the CPU 10, executing the conflict resolution module 610, determines if there is a conflict. As noted above, there are two types of conflicts. In an aspect of the disclosure, the CPU 10 separately determines each type of conflict. For example, the CPU 10, executing the conflict resolution module 610, examines all candidate changes for each attribute, e.g., score, size and type to determine if there are multiple candidates for each category (score, size and type). For example, are there two different scores? Sizes? Types? When there are multiple candidates for each category, the CPU 10, determines that there is a first type of conflict for the attribute (“Y” at S710) otherwise there is no first type of conflict.

When a first type of conflict is determined, the CPU 10 then determines what candidates changes are in conflict at S715 (e.g., is it score, size and/or type). At S720, the CPU 10, executing the conflict resolution module 610, retrieves the preset priority for candidate changes. In an aspect of the disclosure, the UESME may set a default for candidates determined from the preset parameter 320 as being higher priority. In another aspect of the disclosure, the UESME may set a default that candidates determined from machine learning parameters 325 are higher in priority. In another aspect of the disclosure, the UESME may set different default for score, size and type. For example, the UESME may set the score and size as having priority when determined from the preset parameters 320 whereas a type may have priority when determined from machine learned parameter 325.

At S725, the CPU 10, executing the conflict resolution module 610, applies the set default to select the candidate change, e.g., one score and/or one size and/or one type, from the multiple scores, sizes and/or types, respectively.

Once selected, the CPU 10, executing the conflict resolution module 610, will start the process of determining whether there is a second type of conflict by retrieving the current display information from memory 20 (e.g., currently displayed front end visualization 300) at S730. The process is also started when there is no first type of conflict (“N” at S710).

At S735, the CPU 10, executing the conflict resolution module 610, determines whether there is a conflict in position. Typically, the update will occur when the dashboard has already been populated with graphics for multiple attributes. Therefore, when the candidate changes include scores and sizes, there will likely be a conflict between a graphic that is currently being displayed for an attribute with a score and size, with a candidate change of a score/size.

The CPU 10 determines whether there is a conflict by comparing the score and size of the attributes currently displayed on the front end display with the score and size for the candidate changes for each attribute. When there is no conflict (“N” at S740), the CPU proceeds to the finalization stage S775.

When the score is the same or when the score is different but a size would result is the same position, a conflict is determined (“Y” at S740). For example, when att5 is currently displayed at 1.1 with size 1 and att4 is displayed at 1.2 with size 1 and a candidate change for att1 is 1.1 with size 2, there is a conflict in both regions 1.1 and 1.2. At S745, the CPU 10, executing the conflict resolution module 610, determines which attribute(s) are in conflict, e.g., the attributes that would occupy the same score region.

For instance, based on the above example, the CPU 10 would determine there is a conflict between att1, att4 and att 5 that needs to be resolved.

At S750, the CPU 10, executing the conflict resolution module 610, retrieves the preset priority information from memory 10 (“preset conflict resolution 330”). In an aspect of the disclosure, the preset conflict resolution may include a conflict table, an example, of such a table is shown in FIG. 12. The conflict table 1200 contains rows and columns reflecting possible combinations of attributes and attribute threshold combinations. When there is a “x” in the cell there is no conflict as the comparison is between the same attribute or attribute/threshold. An attribute/threshold listing in a cell, indicates the higher priority. As shown in the conflict table, Att1/THA has a higher priority than Att5, no threshold.

The conflict table 1200 has been partially filled in for the purpose of this description. For example, five potential conflicts have been filled in. However, a DSME and UESME may set all of the cells of the conflict table 1200 in advance. FIG. 12 depicts a two dimensional conflict table; however, a higher dimensional conflict table may be used.

The conflict resolution module 610 may also include machine learning which updates the priority information in the conflict table (S765). In an aspect of the disclosure, the DSME and UESME may set a default that the conflict table may be updated via the machine learning. In another aspect of the disclosure, the DSME and UESME may receive a notification that the machine learning has generated updated priority information and the DSME and UESME may chose to update the priority information upon inspection of the machine learned updated priority information (stored in memory as 340). The DSME and UESME will train the conflict resolution module 610 to update the priority information. The conflict resolution module may contain any of the machine learning software described above.

Accordingly, the retrieving of the priority information in S750 may include machine learning conflict parameters along with the preset conflict information.

At S755, the CPU 10, executing the conflict resolution module 610, will read out the priority information from the corresponding cell(s) as needed to determined priority. The attribute (attribute/threshold combination) that has the higher priority is giving the conflicted score region. For example, if att1 has a higher priority than att4 and att5, att1 will be given the score region 1.1 and 1.2 in the above example.

At S760, the CPU 10, executing the conflict resolution module 610, will change the scores and/or size for the other attributes in conflict. For example, the CPU 10, may lower the score of the other two attributes att4 and att5, to 1.3 and 1.4, respectively and repeated the determination of the second type of conflict (go to S740), as needed. In another aspect of the disclosure, the CPU 10, may swap the scores of the attributes. For example, if the att1 prior to the update, had a score of 2.4, the CPU 10 may adjust the score of att4 or att5 to 2.4 when allowing att1 to have 1.1 at size 2. The adjusted scores and sizes are also saved in candidate changes 345. Thus, the candidate changes may include additional changes to the scores and sizes solely needed to avoid conflict in the visualization or dashboard.

S740-S760 are repeated for each of the score regions/sizes in conflict and attributes until there are no conflicts remaining (“N” at S740).

When there are no conflicts remaining, the CPU 10 proceeds to the finalization stage (S775).

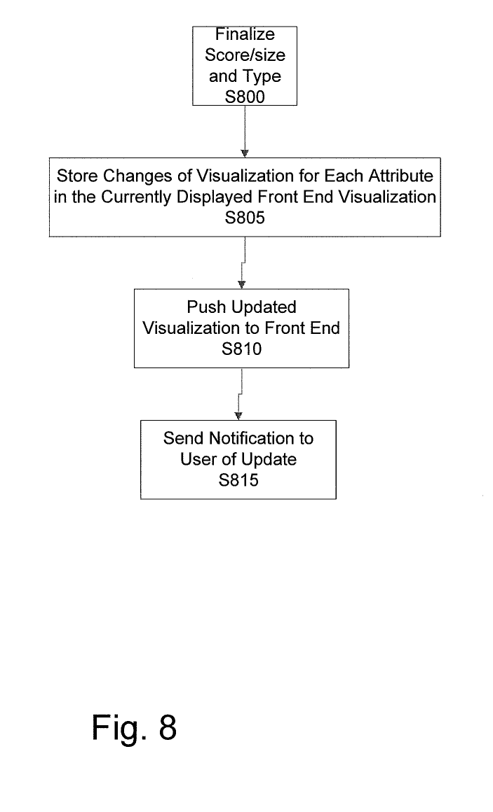

FIG. 8 depicts a flow chart for a finalization of the visualization in accordance with aspects of the disclosure.

S800 and S805 may be performed by the conflict resolution module 610. In another aspect of the disclosure, S800 and S805 may be performed by a separate finalization module (not shown).

At S800, the CPU 10 finalizes the scores, sizes and types for each of the attributes to be displayed. This finalization includes all of the attributes that were changed, e.g., score, size and type as well as attributes that may not have changed. The finalization includes retrieving the score, size and type of graphic for each attribute that did not change and appending them to the scores, sizes and types for all of the attributes that were changes to create the finalized updated dashboard or visualization. The creation also includes adding the new data from the data store to the visualizations, e.g., update the graphic with the new data. At S805, the CPU causes the finalized updated dashboard or visualization to be stored in the currently displayed front end visualization 300 in memory 20.

S810 and S815 may be performed by the notification module 615. At S810, the CPU 10, executing the notification module 615, retrieves the updated dashboard from memory 20 and causes the communication interface 40 to transmit the updated dashboard to the front end display (not shown).

In an aspect of the disclosure, the updated dashboard may be encrypted for transmission. Separately, at S815, the CPU 10, executing the notification module 615, issues a notification to the user that the dashboard has been updated. The notification was described above. In another aspect of the disclosure, the notification module 615 causes any changes in the dashboard to be highlighted temporarily when the dashboard is initially displayed on the front end display.

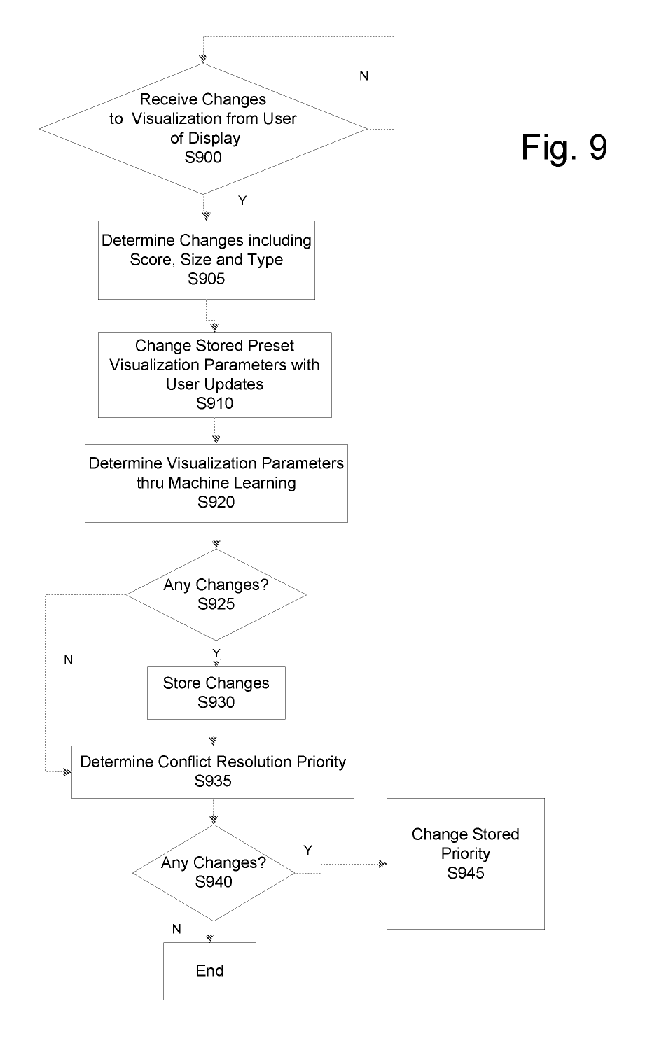

FIG. 9 depicts a flow chart for feedback processing in accordance with aspects of the disclosure. At S900, the CPU 10 determines if the visualization apparatus 1 received any display information from the front end display. The dashboard generated in accordance with aspects of the disclosure, may be modified by the user of the front end display, as desired. When a change occurs, the front end display transmits the display information back to the visualization apparatus 1. The user change may include score, size and/or type.

At S905, the CPU 10 determines what changed. In an aspect of the disclosure, the CPU 10 may compare the stored display information, e.g., parameters in the currently displayed front end visualization 300 (for each attribute) with the parameters received from the front end display.

When the parameters are different, a change is determined. In an aspect of the disclosure, the changes may trigger the preset visualization module 600 to update the preset visualization parameters 320 in memory 20 at S910. The CPU 10, executing the preset visualization module 600, may overwrite the existing parameters based on the changes, e.g., change the preset score, size and/or type, using the changed score, size and/or type, respectively.

Also, the changes may trigger the machine learning visualization module 605 to determine whether the machine learned visualization parameters need to be updated based on the change. In an aspect of the disclosure, the machine learning visualization module 605 retrieves the stored aggregations 315, parameter 325 and obtains the changes received from the front end display and updates to the parameter 325, as needed. When there are changes (“Y” at S925), the changes are stored in machine learned visualization parameters 325 in the memory 20.

Changes to the preset visualization parameters 320 and the machine learned visualization parameters 325 may cause a change in the conflict table 1200. At S935, the CPU 10, executing the conflict resolution module 610, determines if the conflict table 1200 needs to be changed. Certain changes may not impact the priority such as a change is type. Other changes may impact priority, such as, score and/or size.

At S940, the CPU 10 determines that the changes impact priority, (“Y” at S940), the CPU 10 may update the conflict table 1200 at S945. For example, if the change received from the front end display changed a score of att1 and att5, respectively, where att5 is given a higher score than att1, the conflict resolution module 610 may update the conflict table 1200 to reflect the change. In another aspect of the disclosure, instead of updating the conflict table 1200, the CPU 10 may store the change in machine learned conflict resolution 340 in memory and cause a notification to be issued to the DSME and/or SME. Before, the change to the conflict table 1200 is implemented, the DSME and/or SME may inspect the change and approve.

If at S940, the CPU 10 determines that the changes (received from the front end display), does not impact priority, the feedback process ends.

Various aspects of the present disclosure may be embodied as a program, software, or computer instructions embodied or stored in a computer or machine usable or readable medium, or a group of media which causes the computer or machine to perform the steps of the method when executed on the computer, processor, and/or machine. A program storage device readable by a machine, e.g., a computer readable medium, tangibly embodying a program of instructions executable by the machine to perform various functionalities and methods described in the present disclosure is also provided, e.g., a computer program product.

The computer readable medium could be a computer readable storage device or a computer readable signal medium. A computer readable storage device, may be, for example, a magnetic, optical, electronic, electromagnetic, infrared, or semiconductor system, apparatus, or device, or any suitable combination of the foregoing; however, the computer readable storage device is not limited to these examples except a computer readable storage device excludes computer readable signal medium. Additional examples of the computer readable storage device can include: a portable computer diskette, a hard disk, a magnetic storage device, a portable compact disc read-only memory (CD-ROM), a random access memory (RAM), a read-only memory (ROM), an erasable programmable read-only memory (EPROM or Flash memory), an optical storage device, or any appropriate combination of the foregoing; however, the computer readable storage device is also not limited to these examples. Any tangible medium that can contain, or store, a program for use by or in connection with an instruction execution system, apparatus, or device could be a computer readable storage device.

A computer readable signal medium may include a propagated data signal with computer readable program code embodied therein, such as, but not limited to, in baseband or as part of a carrier wave. A propagated signal may take any of a plurality of forms, including, but not limited to, electro-magnetic, optical, or any suitable combination thereof. A computer readable signal medium may be any computer readable medium (exclusive of computer readable storage device) that can communicate, propagate, or transport a program for use by or in connection with a system, apparatus, or device. Program code embodied on a computer readable signal medium may be transmitted using any appropriate medium, including but not limited to wireless, wired, optical fiber cable, RF, etc., or any suitable combination of the foregoing.

The terms “Processor” an example of which was a CPU, as may be used in the present disclosure may include a variety of combinations of fixed and/or portable computer hardware, software, peripherals, and storage devices. The “Processor” may include a plurality of individual components that are networked or otherwise linked to perform collaboratively, or may include one or more stand-alone components. The hardware and software components of the “Processor” of the present disclosure may include and may be included within fixed and portable devices such as desktop, laptop, and/or server, and network of servers (cloud).

The terminology used herein is for the purpose of describing particular embodiments only and is not intended to be limiting the scope of the disclosure and is not intended to be exhaustive. Many modifications and variations will be apparent to those of ordinary skill in the art without departing from the scope and spirit of the disclosure.

What is claimed is:

1. A non-transitory computer-readable medium comprising instructions, that, when executed by at least one processor of a computing device, cause the computing device to:
poll, periodically a data store for changes in data or schema;
determine whether the data or schema has changed;
update, using at least the changed data or schema, aggregations of the data;
generate at least one new aggregation of the data, using at least the changed data or schema;
determine whether the updated aggregations or the at least one new aggregation of the data triggers a visualization change for a display of attributes in a display visualization, respectively associated with the updated aggregations or the at least one new aggregation;
determine the visualization change for the display of the attributes, respectively associated with the updated aggregations or the at least one new aggregation, the visualization change including at least one of position on a display, size of a graphic and type of the graphic for at least one of said attributes;
send the visualization change to a display device; and
send a notification to a user indicating the visualization change.

2. The non-transitory computer-readable medium according to claim 1, wherein, the updating of the aggregations of the data further uses at least one of preset mathematical functions, preset logic functions, sorting or grouping.

3. The non-transitory computer-readable medium according to claim 1, wherein, the generating of the at least one new aggregation of the data is based on machine-learning, whereby the at least one processor creates one or more of additional mathematical function, an additional logic function, sorting or grouping to apply to the data, based on analysis of at least the changed data or schema.

4. The non-transitory computer-readable medium according to claim 1, wherein, the determining of whether the updated aggregations or at least one new aggregation of the data triggers the visualization change for a display of attributes is based on at least one threshold, respectively associated with each of said attributes.

5. The non-transitory computer-readable medium according to claim 4, wherein the at least one threshold is a plurality of thresholds and one of the thresholds is based on machine-learning, whereby the at least one processor generates the one threshold based on analysis of at least the changed data or schema.

6. The non-transitory computer-readable medium according to claim 4, wherein each of the at least one threshold is further associated with a position on the display, size of the graphic and type of the graphic and wherein the determining of the visualization change is based on a respective value of each attribute and a comparison with the at least one threshold, respectively.

7. The non-transitory computer-readable medium according to claim 6, wherein the position on the display, size of the graphic and type of the graphic associated with one of the at least one threshold varies based on machine-learning, whereby the at least one processor varies the position on the display, size of the graphic and type of the graphic associated with one of the at least one threshold based on an analysis of at least the changed data or schema.

8. The non-transitory computer-readable medium according to claim 6, wherein the display visualization is divided into a matrix of predetermined positions, each of the predetermined positions being identified by a specific score and wherein the position on the display associated with each of the at least one threshold, respectively, is the specific score for one predetermined position.

9. The non-transitory computer-readable medium according to claim 8, wherein each of the predetermined positions is the same size.

10. The non-transitory computer-readable medium according to claim 8, wherein the size of the graphic is a number of predetermined positions which the graphic is displayed.

11. The non-transitory computer-readable medium according to claim 1, wherein the type of graphic further includes type of font, size of font, color of font or graphic.

12. The non-transitory computer-readable medium according to claim 8, further comprising instructions, that, when executed by the at least one processor of the computing device, cause the computing device to further: perform conflict resolution between two or more attributes when the determined visualization change is in conflict, said conflict including two or more attributes having the same specific score.

13. The non-transitory computer-readable medium according to claim 12, wherein said conflict resolution is based on a first priority order between the two or more attributes in conflict.

14. The non-transitory computer-readable medium according to claim 13, wherein said conflict resolution is further based on a second priority order between thresholds for the attributes.

15. The non-transitory computer-readable medium according to claim 14, wherein the first priority order and the second priority order is based on machine-learning, whereby the at least one processor generates the first priority order and the second priority order based on analysis of at least the changed data or schema.

16. The non-transitory computer-readable medium according to claim 8, wherein a currently displayed visualization is stored in a storage in the computing device and wherein determining whether the updated aggregations or the at least one new aggregation of the data triggers the visualization change for the display of the attributes in the display visualization is further based on a comparison of the currently displayed visualization with the position on the display, the size of the graphic and the type of the graphic associated with each of the at least one threshold for each attribute.

17. The non-transitory computer-readable medium according to claim 16, wherein the visualization change is stored in the storage of the computing device as the currently displayed visualization for subsequent comparison.

18. The non-transitory computer-readable medium according to claim 1, wherein the notification is a mobile push notification.

19. The non-transitory computer-readable medium according to claim 1, wherein the notification is pop-up screen on the display device.

20. The non-transitory computer-readable medium according to claim 1, further comprising instructions, that, when executed by the at least one processor of the computing device, cause the computing device to further: highlight temporarily the visualization change.
